(19) United States
(12) Patent Application Publication
(10) Pub. No.: US 2024/0205147 A1
(43) Pub. Date: Jun. 20, 2024

(54) FORCED FORWARDING ADDRESSING COMMUNICATIONS

(71) Applicant: ITRON, INC., Liberty Lake, WA (US)

(72) Inventors: Keith Wayne BARNES, Waseca, MN (US); Imad JAMIL, Beynes (FR); Thomas F. UHLING, Spokane Valley, WA (US)

(21) Appl. No.: 18/069,130

(22) Filed: Dec. 20, 2022

(51) Int. Cl. H04L 45/74

(52) U.S. Cl. CPC H04L 45/74; H04L 67/12

(57) ABSTRACT

Various embodiments disclosed herein provide communication techniques using forced forward addressing. In various embodiments, a method includes receiving, by a first node of a mesh network, a first unicast message from a second node, wherein the first node is coupled to one or more of child nodes that are neighbor nodes to the first node; determining, by the first node, that a destination address of the first unicast message is a forced forward address; and in response to determining that the destination address is a forced forward address, forwarding, by the first node, the first unicast message to the one or more of child nodes by transmitting respective second unicast messages to the one or more of child nodes.

### BACKGROUND

### Field of the Various Embodiments

The various embodiments relate generally to mesh networks, and more specifically, to a communication technique using forced forward addressing.

### Description of the Related Art

In mesh networks, one or more nodes communicate using one more communication media, such as various wired connections (e.g., Ethernet, power line communication (PLC), or the like) and/or wireless connections (e.g., WiFi®, Bluetooth®, radiofrequency (RF) communication, or the like). Many such mesh networks are self-organized as peer-to-peer networks, in which connections are established in response to the nodes discovering one another rather than based on a predefined topology or a centralized server. In addition, certain communications (e.g., firmware downloads) often need to be transmitted to each available node in the network.

### BRIEF DESCRIPTION OF THE DRAWINGS

So that the manner in which the features of the various embodiments can be understood in detail, a description of the inventive concepts may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer system, according to one or more aspects of the various embodiments;

FIG. 2 illustrates an example flow diagram showing transmission of a message that includes a forced forward address in a mesh network, according to one or more aspects of the various embodiments;

FIGS. 3A-3B illustrate a flow diagram of method steps for transmitting a message including a forced forward address, according to one or more aspects of the various embodiments;

FIG. 4 illustrates an exemplary message including a forced forward address, according to one or more aspects of the various embodiments;

FIG. 5 illustrates an exemplary node device that can be included in a mesh network and which is configured to implement one or more aspects of the various embodiments; and

FIG. 6 illustrates a network system, according to one or more aspects of the various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

In a mesh network, nodes of the mesh network can transmit messages to other nodes in the mesh network. In certain circumstances, a common message may need to be sent to a group of nodes in the mesh network. For example, in an infrastructure including both smart water and gas meters that respectively measure water and gas supplied to various clients, a firmware update may need to be sent to update the firmware on the water meters. A conventional mesh network may address this problem by using a multicast address for the relevant nodes (e.g., to the water meters in the example above) and transmitting a message using a broadcast service. The broadcast service uses a common broadcast slot, channel and time between the nodes.

A drawback with the multicast networking scenario is that it increases the amount of network traffic and consumes significant levels of power. For example, a broadcasting service requires the transmitting node to broadcast a message while the remaining nodes in the mesh network listen on a specific channel at a specific time. The listening window needs to be sufficiently long to ensure that all the nodes receive the message and, as such, the total power consumed by all the simultaneous listening devices in a broadcasting network during an active listening window can be considerable. Furthermore, collisions that prevent successful transmission of the message result when more than one node tries transmitting a message during the same broadcast listening window. This results in the use of additional network bandwidth because both the nodes have to retransmit the message at a later time. Both broadcast listening windows and retransmission of messages can increase power consumption by nodes in a mesh network. Such an increase in power consumption may be particularly impactful to battery-powered devices as it causes batteries to be depleted at an increased rate.

Alternatively, a conventional mesh network can address the challenge of needing to send a common message to each of the nodes or a group of nodes by using unicast messaging whereby a uniquely addressed message needs to be transmitted to each of the nodes in the mesh network or each of the nodes in the group. One drawback of a mesh network using unicast messaging in this way is that each node in the network needs to be uniquely addressed, which requires creating and transmitting a unique message (e.g., from an access point) for each node in the network. This typically results in each node in the network processing at least as many messages as the number of child nodes with which each node is associated, which increases both network traffic and the power consumed by each node.

As discussed below, a solution to the above problems is to use a forced forward addressing mechanism. As used herein, forced forward addressing refers to a mechanism whereby to transmit a message to nodes in a mesh network with multiple nodes, each node in the network receives a single message and forwards the message to all of its neighboring children in a sub-tree of the network (instead of having to receive and forward copies of a message for each node in a sub-tree below the node in a hierarchy of the mesh network). A forced forward address is identified by a distinct sequence of address bits within a designated address range, such as an address range in which the leading bits have the distinct sequence of address bits. The forced forward address indicates to a recipient node of the message that the node is to forward the message on to all the neighboring child nodes of the node. When using forced forward addressing, a first node that wants to transmit a common message to all the nodes in a mesh network or a group of nodes within the mesh network, prepares a message with a forced forward address. This first node then transmits the message to all of the neighboring child nodes of the first node. When a child node receives a message from a neighboring parent node (such as the first node), the child node checks to see whether a destination address for the message is a forced forward address. When the destination is a forced forward address, the child node forwards the message to all of the neighboring child nodes of the child node, which are grandchild nodes of the first node. This continues until the message is forwarded to every node in the mesh network below the first node that prepared and transmitted the initial messages with the forced forward address. This allows a first node that wants to distribute a message to all of the nodes in a subset of the mesh network below the first node in a hierarchy of the mesh network (e.g., a sub-tree of the mesh network) by sending only one message to each of the neighboring child nodes of the first node rather than having to address and transmit a separate message for each and every node in the subset. Additionally, a portion of the forced forward address can include a group address, which is usable to identify which of the nodes in the sub-tree are desired recipients of the message and should further process the content of the message in addition to forwarding the message to all neighboring child nodes.

At least one technical advantage of the disclosed techniques is that the disclosed techniques reduce the amount of network traffic. Instead of having to receive and forward copies of a message for each node in a sub-tree below the node in a hierarchy of the mesh network, a node receives only one message and forwards the message only to its neighboring children in the sub-tree. This not only reduces the total number of messages that need to be received and transmitted in the network, but also reduces bandwidth usage in the network and reduces the amount of power that is consumed by devices implementing the nodes in the network. Another technical advantage of the disclosed techniques is that, with the disclosed techniques, the nodes do not need to implement a separate multicast listening window used only for messages to be distributed to the entire mesh network or a sub-tree of the mesh network. This reduces the complexity of listening window management by the nodes and further reduces their power consumption.

### Forced Forward Addressing

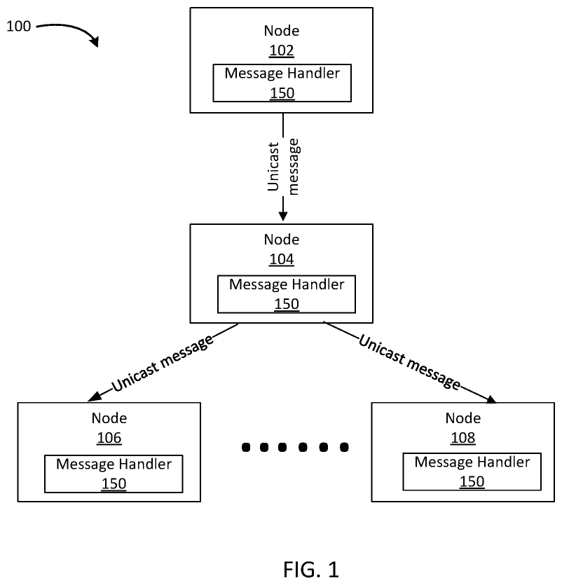

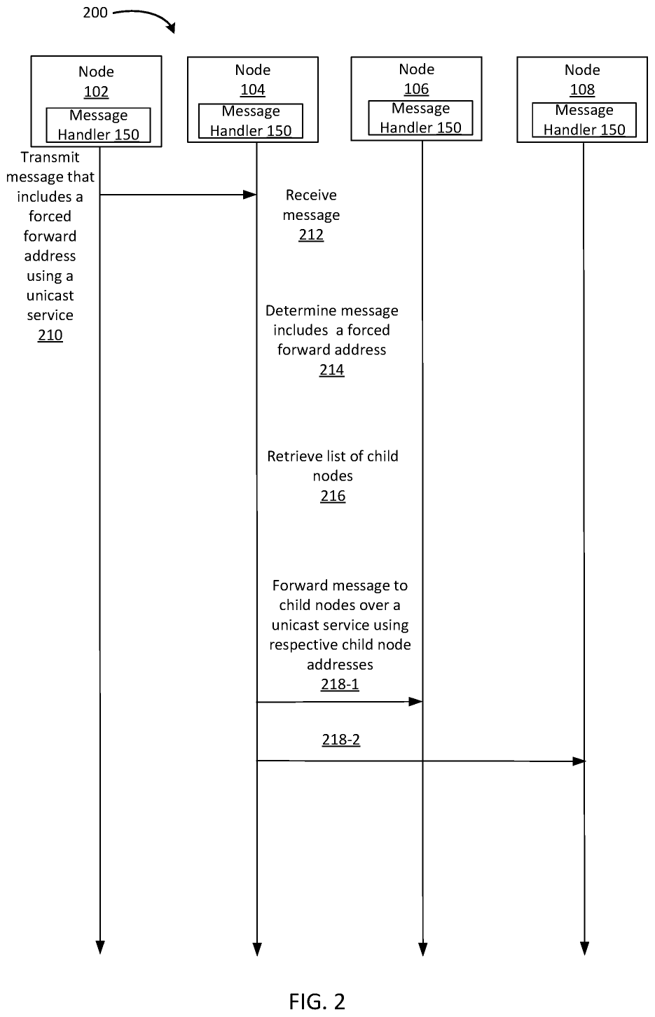

Referring now to FIG. 1, a block diagram of a computer system 100 is shown. In various embodiments, computer system 100 includes, without limitation, a node 102, a node 104, a node 106 and a node 108. As discussed in additional detail in reference to FIG. 2, in various embodiments nodes 102, 104, 106, and 108 are nodes of a mesh network that are operable to communicate with each other and other nodes in the mesh network. In various embodiments, forced forward addressing is implemented by each node in the mesh network. When node 102 wants to transmit a common message to nodes 104, 106, and 108 in the mesh network, node 102 prepares a message with a forced forwarding address. Node 102 transmits a unicast message with the forced forwarding address to node 104, which is a neighboring child node of node 102. When node 104 receives the message, node 104 checks to see whether a destination address for the message is a forced forward address. When the destination address is a forced forward address, node 104 forwards the message to neighboring child nodes 106 and 108 as respective unicast messages. According to the techniques discussed below in further detail in reference to FIG. 2, nodes 102, 104, 106 and 108 are able to process and forward messages to other nodes using a message handler application 150.

FIG. 2 illustrates an example flow diagram showing a process 200 for transmitting a message that includes a forced forward address in a mesh network, according to one or more aspects of the various embodiments. Although the interactions between the nodes in a mesh network are shown in an order, persons skilled in the art will understand that the interactions may be performed in a different order, interactions may be repeated or skipped, and/or may be performed by components other than those described in FIG. 1.

As shown in FIG. 2, nodes 102 to 108 of a mesh network are connected by a communication medium (not shown). The communication medium can be, for example, a wired connection (e.g., an Ethernet connection or a power line communication connection) or a wireless connection (e.g., a Wi-Fi connection, a Bluetooth connection, or any other type of wireless connection). Although not shown, nodes 102, 104, 106 and 108 can be in communication with other nodes of the mesh network (not shown) by the same communication medium or different communication media. Nodes 102, 104, 106 and 108 are configured to execute a message handler application 150, which could, for example, be a software agent. Message handler application 150 performs functions such as (without limitation) transmitting, receiving, encrypting and/or decrypting communications (e.g., messages) to/from other nodes (e.g., with each other). Further, message handler application 150 enables nodes to detect if a destination address for a message received from a neighboring parent node is a forced forward address. The message handler application 150 is also able to process the contents of a received unicast message and forward it on to a neighboring child node as a unicast message.

As shown, process 200 begins at step 210, in which, using message handler application 150, node 102 transmits a message that includes a destination address (e.g., a MAC address, etc.) to node 104 using a unicast service. A unicast service is a one-to-one communication channel between two nodes in the network, where each node communicates during a time window and over a frequency that is distinct to the node. The message might be, for example, a network packet (e.g., a User Datagram Protocol (UDP) packet, a TCP packet, an IPv6 packet). The destination address included in the message can be a forced forward address, which in some embodiments, is identified by a distinct sequence of address bits within a designated address range, such as an address range in which the leading bits have the distinct sequence of address bits. The forced forward address indicates to a recipient node of the message that the node is to forward the message on to all the neighboring child nodes of the node.

In some embodiments, node 102 is a root node of a mesh network and receives the message including the forced forward address initially from an access point in the network. For example, the message received from the access point could include a firmware download to be transmitted to all the nodes in the mesh network below node 102. In some embodiments, node 102 is located below the root node in the hierarchy of the mesh network and received the message including the forced forward address from a neighboring parent node.

In some embodiments, node 102 can also originate the message. For example, node 102 can generate the message in response to losing connection with a neighboring parent node or a root node of the mesh network. The message would be distributed to the sub-tree for node 102 to inform the sub-tree that node 102 has lost connection with the neighboring parent node or the root node.

At step 212, node 104 receives the message from node 102 over the unicast service. At step 214, message handler application 150 in node 104 determines whether the message received from node 102 includes a forced forward address.

In some embodiments, message handler application 150 extracts the destination address from the designated address range in the message and compares the destination address to a sequence of bits stored in memory that corresponds to the forced forward address.

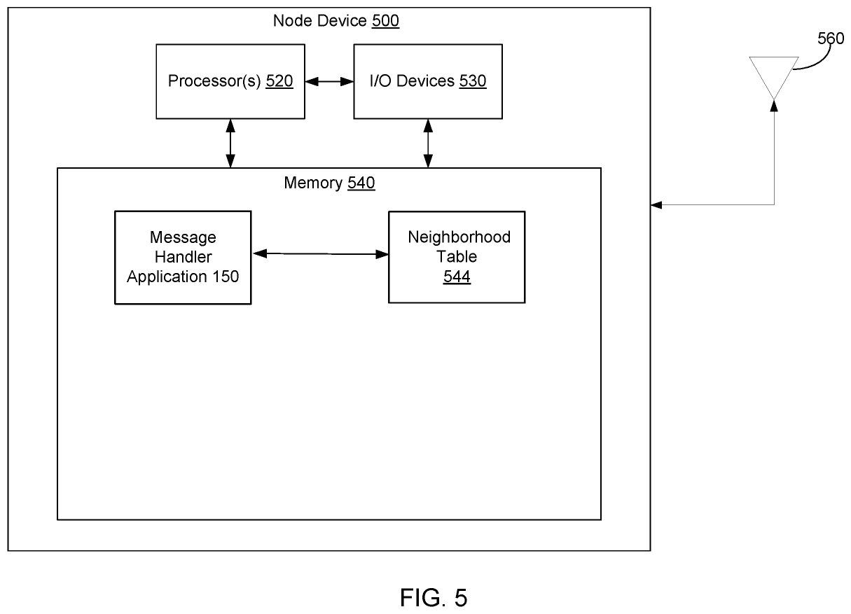

In response to determining that the message includes the forced forward address, at step 216, node 104 retrieves information pertaining to its neighboring child nodes. In some embodiments, the information comprises a list of addresses or other identifiers for the neighboring child nodes retrieved from a neighborhood table. In some embodiments, each node stores and updates its own copy of the neighborhood table (e.g., as shown in FIG. 5 described below).

Using the addresses of the neighboring child nodes, at steps 218-1 and 218-2, message handler application 150 in node 104 forwards the message to neighboring child nodes 106 and 108 using respective unicast messages delivered over respective unicast services. In some embodiments, the message is forwarded to each neighboring child node over the unicast service for that neighboring child node. A child node does not typically share its unicast service, unicast channel and unicast time with another child's unicast service. In addition to forwarding the message to neighboring child nodes, if node 104 is an intended recipient of the message, node 104 also extracts the payload from the message and processes the payload.

Each of the neighboring child nodes then forwards the message on to the neighboring child nodes of the respective neighboring child node. This process continues until the message is distributed to all the nodes in the subset of the mesh network below the first node in the hierarchy of the mesh network.

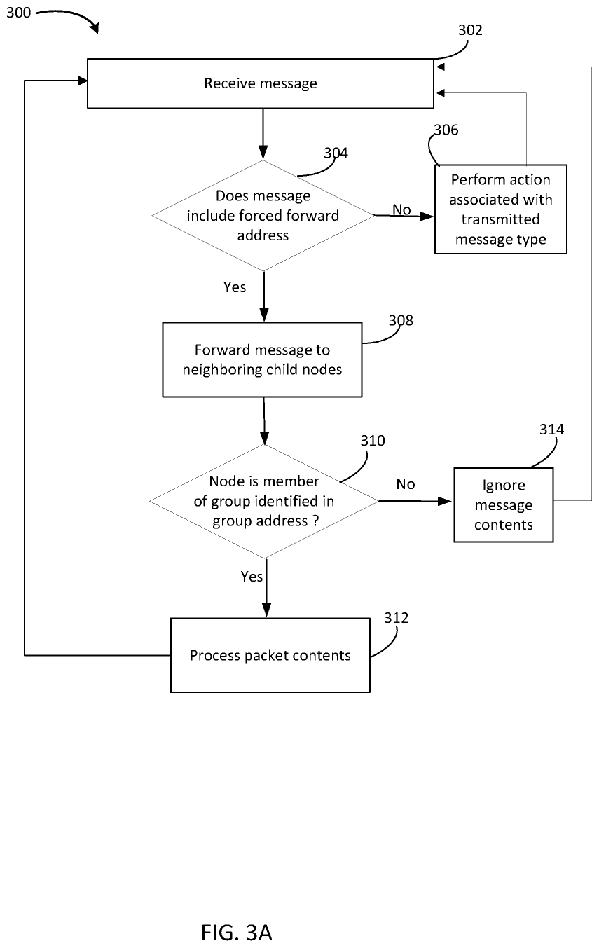

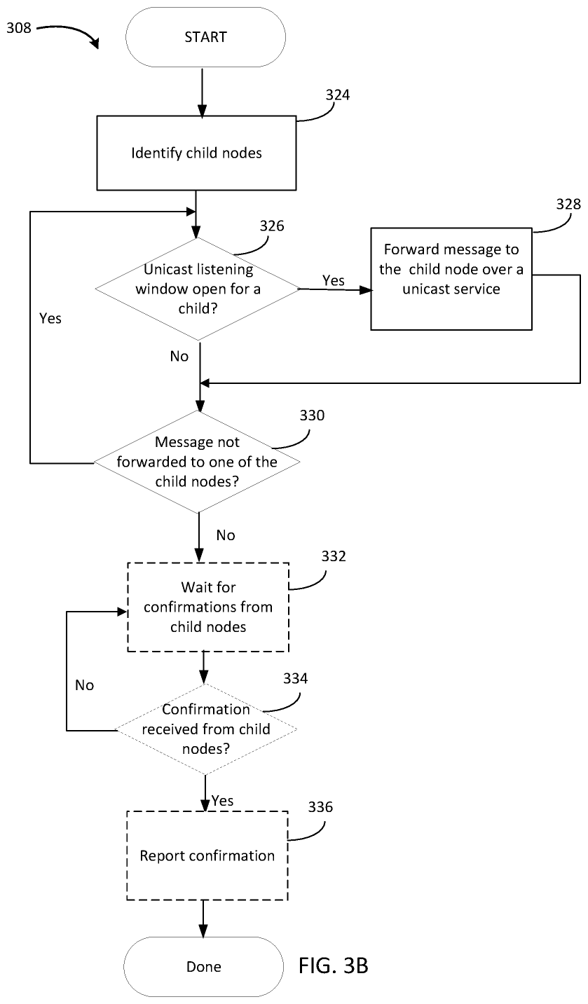

FIGS. 3A-3B illustrate a flow diagram of method steps for transmitting a message including a forced forward address, according to one or more aspects of the various embodiments. The method steps of FIGS. 3A-3B can be performed, for example, by nodes 102, 104, 106 or 108 of FIGS. 1-2. At least some of the method steps of FIGS. 3A-3B can be performed, for example, during the process 200 of FIG. 2.

As shown, a method 300 begins at step 302, where a message handler application 150 executing on a first node in a mesh network receives a message from a message handler application executing on a second node. It should be noted that the first node can be any of the nodes in the mesh network (e.g., node 102, 104, 106 or 108) while the second node corresponds to a neighboring parent node of the first node that generated the message. As noted above, in some embodiments, the second node that generated the message is a root node of a mesh network receiving the message from an access point in the network. In some embodiments, the second node is located below the root node in the hierarchy of the mesh network and receives the message from a neighboring parent node. Further, in some embodiments, the second node can also originate the message. In some embodiments, the message includes a destination address (e.g., a MAC address, etc.) and is received using a unicast service.

At step 304, the message handler application 150 executing on the first node determines if the destination address included in the unicast message is a forced forward address. For example, the first node can determine if the destination address of the unicast message based on whether the destination address is within a range of forced forward addresses.

At step 304, if the destination address is not a forced forward address (304—No), then the method 300 proceeds to step 306. At step 306, the message handler application 150 executing on the first node performs an action associated with the transmitted message type. For example, the message handler application 150 can decode a header of the message to determine a type of the message. Based on the type of the message, the message handler application 150 performs one or more actions associated with the transmitted message type. In some embodiments, the one or more actions are determined based on a protocol associated with the message, a type of data included in the message, and/or the like. The method 300 then returns to step 302, where the first node can receive another message.

At step 304, if the message includes a forced forward address (304—Yes), then method 300 proceeds to step 308. At step 308, the message handler application 150 executing on the first node forwards the message to the neighboring child nodes of the first node using message handler application 150 over a respective unicast service associated with each of the neighboring child nodes, as is discussed further in connection with FIG. 3B.

At step 310, the message handler application 150 executing on the first node determines whether the first node is a member of a group identified in the group address component of the destination address. As noted previously, in some embodiments, the message is directed to a subset of the nodes within a mesh network. For example, in an infrastructure including different types of devices (e.g., smart meter devices, sensor devices, etc.) corresponding to the nodes in a mesh network, a firmware update may need to be sent to update only the firmware on a particular group of devices. Accordingly, the message handler application 150 at each node in the mesh network determines whether the node belongs to a group addressed by the message. In some embodiments, each node in the mesh network can belong to more than one group. For example, a device associated with a node can have multiple functions (e.g., a device can be both an electric meter and a battery powered device) and, accordingly, can be part of multiple groups.

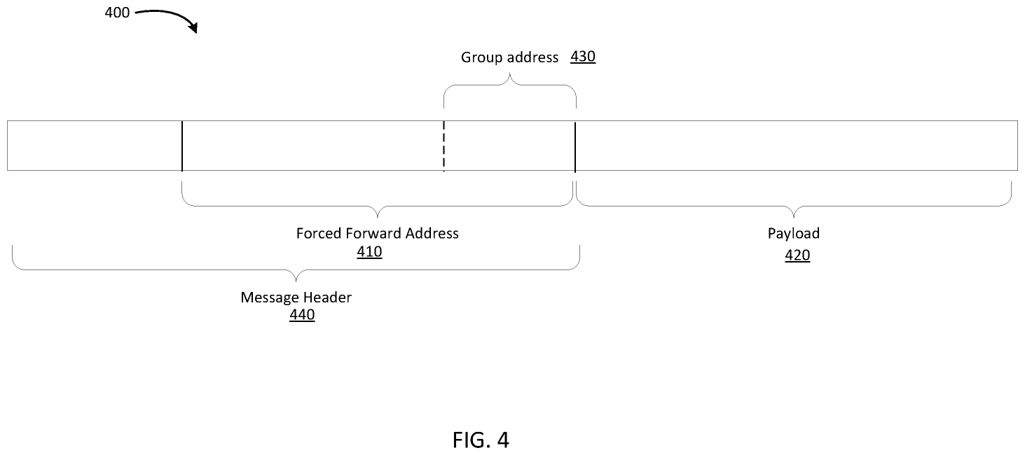

FIG. 4 illustrates an exemplary message 400 including a forced forward address, according to one or more aspects of the various embodiments. As shown in FIG. 4, a message 400 includes a message header 440 and a payload 420. The destination address included in the message header 440 is a forced forward address 410, which in some embodiments, is identified by a distinct sequence of address bits within a designated address range, such as an address range in which the leading bits have the distinct sequence of address bits. In some embodiments, a portion of the forced forward address includes a group address field 430 to identify a group of nodes that are desired recipients of message 400. In some embodiments, each node in the mesh network can be a member of more than one group and can, accordingly, be associated with more than one distinct group address. The group address field 430 is usable to identify which of the nodes in the network are desired recipients of the message 400 and should further process the content of the message in addition to forwarding the message to all neighboring child nodes.

Returning to FIG. 3A, at step 310, if the message handler application 150 determines that the first node is a member of a group identified in the group address field of the message (304—Yes), then the method proceeds to step 312. At step 312, the message handler application 150 executing on the first node processes the packet contents (e.g., the contents extracted from payload 420 of message 400) of the received message. For example, if the message contains a firmware update intended for a device associated with the first node, the device updates the firmware based on the contents of the message. Or, for example, if the message contains a portion of a firmware update intended for a device associated with the first node, the device consolidates the portion with other prior received portions and waits for the entire update to be received prior to processing. By way of further example, the payload 420 may contain updated operational settings for a particular group of devices (e.g., updated factory default settings for smart water meters). Other types of messages that may need to be transmitted to nodes in the mesh network can include configuration data, information regarding a lost connection, a request for connectivity status, a request for a group identification, a firmware download, and the like. The method 300 then returns to step 302, where the first node can receive another message.

At step 310, if the message handler application 150 determines that the first node is not a member of a group identified in the group address field of the message (304—No), then at step 314, the message handler application 150 executing on the first node ignores the contents of the message and the method 300 then returns to step 302, where the first node can receive another message. Note that message handler application 150 executing on the first node forwards the message to the neighboring child nodes of the first node at step 308 irrespective of whether the first node is identified as being part of a group intended to receive and process the message. Accordingly, steps 310, 312 and 314 of the method 300 are not limited to being performed subsequent to step 308. Steps 310, 312 and 314 can be performed either contemporaneously with step 308 or even prior to step 308.

FIG. 3B illustrates a flow diagram of method steps for forwarding the message at step 308 of FIG. 3A, according to one or more aspects of the various embodiments. As shown, the step 308 of FIG. 3B begins at step 324, where the message handler application 150 executing on the first node identifies neighboring child nodes (e.g., message handler application 150 at node 104 identifies nodes 106 and 108). In some embodiments, the first node retrieves information pertaining to its neighboring child nodes from a neighborhood table in the form of a list of addresses or other identifiers for the neighboring child nodes. In some embodiments, each node stores and updates its own copy of the neighborhood table, as will be discussed further in connection with FIG. 5.

At step 326 in which the first node determines if a unicast listening window is open on one or more neighboring child nodes (e.g., node 104 determines if a unicast listening window is open on either node 106 or 108 or both). In some embodiments, the first node consults a listening window schedule for one or more neighboring child nodes identified during step 324. In some embodiments, this schedule is stored in the neighborhood table.

In some embodiments, the first node waits for a unicast listening window to open on each of the neighboring child nodes during a scheduled window of time associated with a respective neighboring child node. A neighboring child node can, for example, publish a frequency and a time slot during which it is available to accept transmissions from a node. For example, as noted above, the neighborhood table, for each node, can store information regarding a schedule for a listening window associated with a respective node. In some embodiments, the first node transmits to two or more of the neighboring child nodes contemporaneously if the listening window for each of the two or more neighboring child nodes is open at the same time.

At step 326, if a unicast listening window for a neighboring child is determined to be open (326—Yes), then at step 328, message handler application 150 executing on the first node forwards the message including the forced forward address to the neighboring child node over a respective unicast service.

In some embodiments, message handler application 150 executing on the first node maintains a timer and a counter for a maximum number of transmission attempts with respect to each neighboring child node. The message handler application 150 executing on the first node initiates the timer as it begins the forwarding process. If a confirmation of receipt (e.g., an acknowledgement) is received, the timer is canceled and the step 308 proceeds forward to step 330. If a confirmation of receipt is not received and the timer exceeds a predetermined threshold value (or times out), the message handler application 150 executing on the first node can make further attempts to forward the message. In some embodiments, if the maximum number of retries to forward the message has been exceeded, the message handler application 150 can abort the forward attempt and optionally report a time out to the second node at step 336 as discussed below. In some embodiments, the maximum number of retries made by the first node can be preconfigured by a user.

At step 326, if a unicast listening window is not open on any of the neighboring child nodes (326—No), then at step 330, the first node determines if there are any neighboring child nodes remaining to which the message has not been forwarded (or for which a corresponding time out has not yet been reported). At step 330, if the first node determines that there is at least one neighboring child node to which the message has not been forwarded (or a corresponding time out has not been reported) (330—Yes), the step 308 returns to step 326. Alternatively, at step 330, if the first node determines that the message has been forwarded to each neighboring child node (330—No), the message handler application 150 continues to wait for acknowledgments and/or time outs for each of the copies of the message forwarded by step 328.

Optionally, in some embodiments, the first node waits for receipt confirmations from the neighboring child nodes and/or time outs and reports the confirmations and/or time outs to the second node that transmitted the message to the first node. As shown, at optional step 334, the first node waits for confirmations from all neighboring child nodes of the first node and/or time outs. At optional step 334, if the first node determines that a confirmation has been received for each copy of the message sent to the neighboring child nodes (334—Yes), then step 308 proceeds to optional step 336. At optional step 336, the first node reports the confirmations out to the second node. At step 334, if a confirmation has not been received from even one of the neighboring child nodes (334—No), the step 308 returns to step 332 to wait for the remainder of the confirmations.

FIG. 5 illustrates an exemplary node 500 that can be included in a mesh network and used to implement the techniques discussed above with respect to FIGS. 1-4. In some embodiments, node 500 is suitable for use with any of the nodes 102, 104, 106, and/or 108. Node 500 includes, without limitation, one or more processors 520, one or more input/output (I/O) devices 530, one or more transceivers 560, and a memory 540.

Node 500 is a network device and includes computing device hardware configured to perform various processing operations and execute program code. The node can further include various analog-to-digital and digital-to-analog converters, digital signal processors (DSPs), harmonic oscillators, transceivers, and any other components generally associated with RF-based communication hardware. In various embodiments, node 500 includes a battery (not shown) that supplies power to the various computing device hardware included in node 500.

The one or more processors 520 can include any hardware configured to process data and execute software applications. At least one of the one or more processors 520 can include a real-time clock (RTC) (not shown) according to which processor 520 maintains an estimate of the current time. At least one of the one or more processors 520 executes a message handler application 150.

The one or more I/O devices 530 include devices configured to receive input, devices configured to provide output, and devices configured to both receive input and provide output. In various embodiments, the one or more I/O devices include a keyboard, a mouse, a joystick, a touchpad, a touchscreen, a microphone, an inertial measurement unit (IMU), a display, a speaker, a haptic generator, or the like. In embodiments where the exemplary node 500 is a utility metering device, the one or more I/O devices can include one or more of a volume measurement unit, a pressure measurement unit, a voltage measurement unit, a current measurement unit, sensors, and the like.

The one or more transceivers 560 can include one more interfaces that are associated with various communication media. In various embodiments, the one or more transceivers include at least one of a radio frequency (RF) interface, an Ethernet interface, a power line communication interface, a WiFi® interface, a Bluetooth® interface, or any other interface associated with a communications protocol.

The memory 540 can be implemented by any technically feasible storage medium, including volatile and/or non-volatile storage media. Memory 540 includes, without limitation, a message handler application 150. Message handler application 150 includes program code that, when executed by the one or more processors 520, performs any of the communications (e.g., message receipts, message transmits and forwards, confirmations) functionality (e.g., transmission, reception) described herein. In various embodiments, the communications functionality includes reception, transmission and forwarding of messages over a unicast service, reception of neighboring node information, and/or the like, such as the operations described above in conjunction with FIGS. 1-4.

In various embodiment, memory 540 includes a copy of the neighborhood table 544. As noted above, in various embodiments, each node stores and updates its own copy of the neighborhood table. The information comprises a list of addresses or other identifiers for the neighboring child nodes.

### System Overview

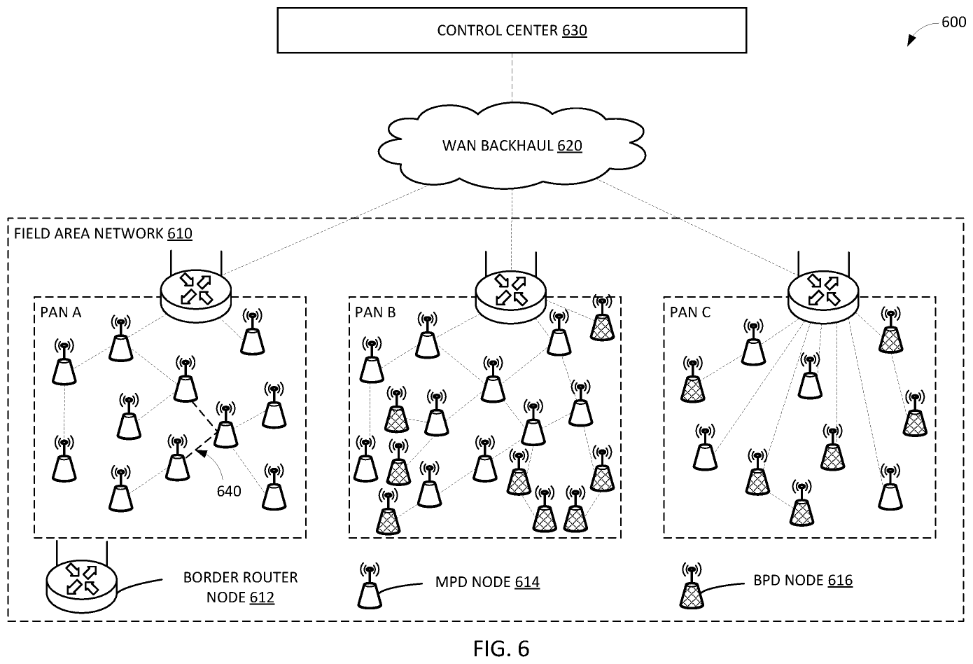

FIG. 6 illustrates a network system configured to implement one or more aspects of the present embodiments. As shown, network system 600 includes a field area network (FAN) 610, a wide area network (WAN) backhaul 620, a control center 630. FAN 610 is coupled to control center 630 via WAN backhaul 620. Control center 630 is configured to coordinate the operation of FAN 610.

FAN 610 includes personal area network (PANs) A, B, and C. PANs A and B are organized according to a mesh network topology, while PAN C is organized according to a star network topology. Each of PANs A, B, and C includes at least one border router node 612 and one or more mains-powered device (MPD) nodes 614. PANs B and C further include one or more battery-powered device (BPD) nodes 616. Any of border router node 612, the one or more MPD nodes 614, or the BPD nodes 616 can be used to implement the techniques discussed above with respect to FIGS. 1-4. In various embodiments, nodes 102, 104, 106 and 108 are implemented as node 612, 614, or 616. Further, node device 500 shown in FIG. 5 can be implemented in FAN 610 as any of nodes 612, 614, and/or 616.

MPD nodes 614 draw power from an external power source, such as mains electricity or a power grid. MPD nodes 614 typically operate on a continuous basis without powering down for extended periods of time. BPD nodes 616 draw power from an internal power source, such as a battery. BPD nodes 616 typically operate intermittently and power down, go to very low power mode, for extended periods of time in order to conserve battery power.

MPD nodes 614 and BPD nodes 616 are coupled to, or included within, a utility distribution infrastructure (not shown) that distributes a resource to consumers. MPD nodes 614 and BPD nodes 616 gather sensor data related to the distribution of the resource, process the sensor data, and communicate processing results and other information to control center 630. Border router nodes 612 operate as access points to provide MPD nodes 614 and BPD nodes 616 with access to control center 630.

Any of border router nodes 612, MPD nodes 614, and BPD nodes 616 are configured to communicate directly with one or more adjacent nodes via bi-directional communication links 640. The communication links 640 may be wired or wireless links, although in practice, adjacent nodes of a given PAN exchange data with one another by transmitting data packets via wireless radio frequency (RF) communications. The various node types are configured to perform a technique known in the art as “channel hopping” in order to periodically receive data packets on varying channels. As known in the art, a “channel” may correspond to a particular range of frequencies. In one embodiment, a node may compute a current receive channel by evaluating a Jenkins hash function based on a total number of channels and the media access control (MAC) address of the node.

Each node within a given PAN can implement a discovery protocol to identify one or more adjacent nodes or “neighbors.” A node that has identified an adjacent, neighboring node can establish a bi-directional communication link 640 with the neighboring node. Each neighboring node may update a respective neighbor table to include information concerning the other node, including one or more of the MAC address of the other node, listening schedule information for the other node, a received signal strength indication (RSSI) of the communication link 640 established with that node, and the like.

Nodes can compute the channel hopping sequences of adjacent nodes to facilitate the successful transmission of data packets to those nodes. In embodiments where nodes implement the Jenkins hash function, a node computes a current receive channel of an adjacent node using the total number of channels, the MAC address of the adjacent node, and a time slot number assigned to a current time slot of the adjacent node.

Any of the nodes discussed above may operate as a source node, an intermediate node, or a destination node for the transmission of data packets. A given source node can generate a data packet and then transmit the data packet to a destination node via any number of intermediate nodes (in mesh network topologies). The data packet can indicate a destination for the packet and/or a particular sequence of intermediate nodes to traverse in order to reach the destination node. In one embodiment, each intermediate node can include a forwarding database indicating various network routes and cost metrics associated with each route.

Nodes can transmit data packets across a given PAN and across WAN backhaul 620 to control center 630. Similarly, control center 630 can transmit data packets across WAN backhaul 620 and across any given PAN to a particular node included therein. As a general matter, numerous routes can exist which traverse any of PANS A, B, and C and include any number of intermediate nodes, thereby allowing any given node or other component within network system 600 to communicate with any other node or component included therein.

Control center 630 includes one or more server machines (not shown) configured to operate as sources for, or destinations of, data packets that traverse within network system 600. The server machines can query nodes within network system 600 to obtain various data, including raw or processed sensor data, power consumption data, node/network throughput data, status information, and so forth. The server machines can also transmit commands and/or program instructions to any node within network system 600 to cause those nodes to perform various operations. In one embodiment, each server machine is a computing device configured to execute, via a processor, a software application stored in a memory to perform various network management operations.

1. According to some embodiments a method comprises receiving, by a first node of a mesh network, a first unicast message from a second node, wherein the first node is coupled to one or more child nodes that are neighbor nodes to the first node; determining, by the first node, that a destination address of the first unicast message is a forced forward address; and in response to determining that the destination address is a forced forward address, forwarding, by the first node, the first unicast message to the one or more child nodes by transmitting respective second unicast messages to the one or more child nodes.

2. The method according to clause 1, wherein the method further comprises retrieving identifiers associated with the one or more child nodes from a neighborhood table prior to forwarding the first unicast message.

3. The method according to clause 1 or clause 2, wherein determining that the destination address is a forced forward address comprises determining that the destination address includes a distinct sequence of address bits associated with forced forward addresses.

4. The method according to any of clauses 1-3, wherein determining that the destination address is a forced forward address comprises determining that the destination address is within an address range designated for forced forward addresses.

5. The method according to any of clauses 1-4, wherein the second node is a parent node to the first node.

6. The method according to any of clauses 1-5, wherein the first unicast message comprises information related to one or more of a firmware update to be processed by nodes in the mesh network, configuration data for devices associated with the nodes, information regarding a lost connection, a request for connectivity status of devices associated with the nodes, a request for a group identification of devices associated with the nodes, and operational settings for devices associated with the nodes.

7. The method according to any of clauses 1-6, further comprising receiving, by the first node of a mesh network, a third unicast message from the second node; determining, by the first node, that a destination address of the third unicast message is not a forced forward address; and in response to determining that the destination address is not a forced forward address, performing, by the first node, an action associated with a message type of the third unicast message.

8. The method according to any of clauses 1-7, further comprising determining, by the first node, that the first node is a member of a group identified within a group address field of the forced forward address; and in response to determining that the first node is a member of the group identified within the group address field of the forced forward address, extracting and processing, by the first node, a payload included in the first unicast message.

9. The method according to any of clauses 1-8, further comprising determining, by the first node, that the first node is not a member of a group identified within a group address field of the forced forward address; and in response to determining that the first node is not a member of the group identified within the group address field of the forced forward address, ignoring a payload included in the first unicast message.

10. According to some embodiments, one or more non-transitory computer-readable media storing instructions which, when executed by one or more processors of a first node device of a mesh network, cause the one or more processors to perform operations comprising receiving a first message from a second node device via a first unicast service; extracting a destination address from a header of the first message; determining that the destination address is a forced forward address; and in response to determining that the destination address is a forced forward address, transmitting respective copies of the first message to one or more child node devices that are neighbors of the first node device using respective second unicast services.

11. The one or more non-transitory computer-readable media according to clause 10, wherein the second node device receives the first message from an access point of the mesh network or a root node device of the mesh network.

12. The one or more non-transitory computer-readable media according to clause 10 or clause 11, wherein transmitting the respective copies of the first message to the one or more child node devices comprises waiting for a unicast listening window to open for a third node device of the one or more child node devices; and in response to determining that a unicast listening window is open for the third node device, transmitting a respective copy of the first message to the third node device during the unicast listening window.

13. The one or more non-transitory computer-readable media according to any of clauses 10-12, wherein the operations further comprise reporting to the second node device that respective confirmations were received from the one or more child node devices that the one or more child node devices received the respective copies of the first message.

14. The one or more non-transitory computer-readable media according to any of clauses 10-13, wherein the destination address comprises a Media Access Control (MAC) address.

15. The one or more non-transitory computer-readable media according to any of clauses 10-14, wherein the operations further comprise generating a second message comprising a destination address that is a forced forward address; and transmitting the second message to the one or more child node devices that are neighbors of the first node device using the respective second unicast services.

16. The one or more non-transitory computer-readable media according to any of clauses 10-15, wherein the operations further comprise, in response to losing a connection with the second node device, generating the second message.

17. According to some embodiments, a networking device in a mesh network comprises one or more processors; and a memory storing executable instructions that, when executed by the one or more processors, cause the one or more processors to receive a message from a parent networking device via a first unicast channel; determining that a destination address extracted from a header of the message is within an address range designated for forced forward addresses; and in response to determining that the destination address is within the address range designated for forced forward addresses, forwarding copies of the message to one or more neighboring child networking devices using respective second unicast channels.

18. The networking device according to clause 17, wherein the parent networking device receives the message from an access point of the mesh network.

19. The networking device according to clause 17 or clause 18, wherein the networking device is a smart meter device or a sensor device.

20. The networking device according to any of clauses 17-19, wherein the message comprises information related to one or more of a firmware download, configuration data, information regarding a lost connection, a request for connectivity status, a request for a group identification, and operational settings.

Any and all combinations of any of the claim elements recited in any of the claims and/or any elements described in this application, in any fashion, fall within the contemplated scope of the present protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method comprising:
receiving, by a first node of a mesh network, a first unicast message from a second node, wherein the first node is coupled to one or more child nodes that are neighbor nodes to the first node;
determining, by the first node, that a destination address of the first unicast message is a forced forward address; and
in response to determining that the destination address is a forced forward address, forwarding, by the first node, the first unicast message to the one or more child nodes by transmitting respective second unicast messages to the one or more child nodes.

2. The method of claim 1, wherein the method further comprises retrieving identifiers associated with the one or more child nodes from a neighborhood table prior to forwarding the first unicast message.

3. The method of claim 1, wherein determining that the destination address is a forced forward address comprises determining that the destination address includes a distinct sequence of address bits associated with forced forward addresses.

4. The method of claim 1, wherein determining that the destination address is a forced forward address comprises determining that the destination address is within an address range designated for forced forward addresses.

5. The method of claim 1, wherein the second node is a parent node to the first node.

6. The method of claim 1, wherein the first unicast message comprises information related to one or more of a firmware update to be processed by nodes in the mesh network, configuration data for devices associated with the nodes, information regarding a lost connection, a request for connectivity status of devices associated with the nodes, a request for a group identification of devices associated with the nodes, and operational settings for devices associated with the nodes.

7. The method of claim 1, further comprising:
receiving, by the first node of a mesh network, a third unicast message from the second node;
determining, by the first node, that a destination address of the third unicast message is not a forced forward address; and
in response to determining that the destination address is not a forced forward address, performing, by the first node, an action associated with a message type of the third unicast message.

8. The method of claim 1, further comprising:
determining, by the first node, that the first node is a member of a group identified within a group address field of the forced forward address; and
in response to determining that the first node is a member of the group identified within the group address field of the forced forward address, extracting and processing, by the first node, a payload included in the first unicast message.

9. The method of claim 1, further comprising:
determining, by the first node, that the first node is not a member of a group identified within a group address field of the forced forward address; and
in response to determining that the first node is not a member of the group identified within the group address field of the forced forward address, ignoring a payload included in the first unicast message.

10. One or more non-transitory computer-readable media storing instructions which, when executed by one or more processors of a first node device of a mesh network, cause the one or more processors to perform operations comprising:
receiving a first message from a second node device via a first unicast service;
extracting a destination address from a header of the first message;
determining that the destination address is a forced forward address; and
in response to determining that the destination address is a forced forward address, transmitting respective copies of the first message to one or more child node devices that are neighbors of the first node device using respective second unicast services.

11. The one or more non-transitory computer-readable media of claim 10, wherein the second node device receives the first message from an access point of the mesh network or a root node device of the mesh network.

12. The one or more non-transitory computer-readable media of claim 10, wherein transmitting the respective copies of the first message to the one or more child node devices comprises:
waiting for a unicast listening window to open for a third node device of the one or more child node devices; and
in response to determining that a unicast listening window is open for the third node device, transmitting a respective copy of the first message to the third node device during the unicast listening window.

13. The one or more non-transitory computer-readable media of claim 10, wherein the operations further comprise:
reporting to the second node device that respective confirmations were received from the one or more child node devices that the one or more child node devices received the respective copies of the first message.

14. The one or more non-transitory computer-readable media of claim 10, wherein the destination address comprises a Media Access Control (MAC) address.

15. The one or more non-transitory computer-readable media of claim 10, wherein the operations further comprise:
generating a second message comprising a destination address that is a forced forward address; and
transmitting the second message to the one or more child node devices that are neighbors of the first node device using the respective second unicast services.

16. The one or more non-transitory computer-readable media of claim 15, wherein the operations further comprise:
in response to losing a connection with the second node device, generating the second message.

17. A networking device in a mesh network, comprising:
one or more processors; and
a memory storing executable instructions that, when executed by the one or more processors, cause the one or more processors to:
receive a message from a parent networking device via a first unicast channel;
determining that a destination address extracted from a header of the message is within an address range designated for forced forward addresses; and
in response to determining that the destination address is within the address range designated for forced forward addresses, forwarding copies of the message to one or more neighboring child networking devices using respective second unicast channels.

18. The networking device of claim 17, wherein the parent networking device receives the message from an access point of the mesh network.

19. The networking device of claim 17, wherein the networking device is a smart meter device or a sensor device.

20. The networking device of claim 17, wherein the message comprises information related to one or more of a firmware download, configuration data, information regarding a lost connection, a request for connectivity status, a request for a group identification, and operational settings.
